(19) United States
(12) Patent Application Publication
(10) Pub. No.: US 2021/0280085 A1
(43) Pub. Date: Sep. 9, 2021

(54) UTERUS SIMULATION MODEL

(71) Applicants: Victoria Eugenia Utria Terán, Philadelphia, PA (US); Michelle Krach, Kingsville, MD (US); Lyndsey Sbarro, Middletown, NY (US); Rachel Junod, Bensalem, PA (US)

(72) Inventors: Victoria Eugenia Utria Terán, Philadelphia, PA (US); Michelle Krach, Kingsville, MD (US); Lyndsey Sbarro, Middletown, NY (US); Rachel Junod, Bensalem, PA (US)

(21) Appl. No.: 17/193,705

(22) Filed: Mar. 5, 2021

Related U.S. Application Data
(60) Provisional application No. 62/985,361, filed on Mar. 5, 2020.

(51) Int. Cl. G09B 23/28; G09B 23/30

(52) U.S. Cl. CPC G09B 23/281; G09B 23/30

(57) ABSTRACT

A simulation device and methods of using a simulation device comprising a plurality of artificial organs and a container, wherein the plurality of artificial organs comprises an artificial uterus; an artificial cervix; an artificial muscle; and an artificial abdominal wall, and wherein the container comprises a lid and an opening. The artificial abdominal wall comprises at least one of an artificial skin, an artificial subcuticula, an artificial fat, and an artificial fascia.

### INCORPORATION BY REFERENCE

Applicant incorporates by reference the entire disclosure of U.S. Provisional Application No. 62/985,361, filed on Mar. 5, 2020.

### FIELD

The present disclosure relates to devices useful for simulating medical procedures, including Cesarean section (CS), and methods of using simulation devices.

### BACKGROUND

Cesarean section (CS) has a mortality rate five times greater than that of vaginal births; however, when performed properly is a lifesaving operation, highlighting the importance of physicians being well trained in the procedure. However, in underserved areas such as many developing countries, this is not the case. Sub-Saharan Africa (SSA) has a population three times that of the USA and has the highest birth rate in the world. Despite the large patient volume, SSA has less than 1% of the number of surgeons as the USA. Uganda, specifically, has a birth rate of 5.59 per woman and a doctor-to-patient ratio of 1:24,725; the World Health Organization recommends 1:1,000. Due to these high patient volumes and limited numbers of trained physicians, CS remains a dangerous procedure in SSA. Ugandan maternal mortality is very high at 343 per 100,000 live births compared to 21.5 per 100,000 in the USA.

Therefore, there is a clear need for improved accessibility and quality of CS training in underserved countries such as Uganda. To address this, in 2015, the Ugandan National Health Ministry implemented a surgical skills training program in partnership with the American College of Obstetricians and Gynecologists and the Drexel University College of Medicine to increase physician competency and improve maternal outcomes. No currently available training models can accurately and affordably simulate CS, leaving program instructors to use low-fidelity, homemade foam-and-fabric models to teach surgical obstetric skills.

Although lifelike, high-fidelity models do exist, they cost upwards of US$50,000 with operation costs of US$200 per use, rendering them inaccessible to the developing world. Even in settings where high-fidelity models are financially viable, the repeated expenses prevent them from being a regular, efficient training method. There is a need in both the developing and developed world to design a mid-fidelity, affordable CS simulation model that allows for robust training and multiple student uses.

### SUMMARY

The present disclosure is related devices useful for simulating medical procedures, specifically Cesarean section (CS).

In certain embodiments, the present disclosure is directed to a simulation device comprising a plurality of artificial organs and a container, wherein the plurality of artificial organs comprises an artificial uterus; an artificial muscle; and an artificial abdominal wall, and wherein the container comprises a lid and an opening.

In certain embodiments of the simulation device, the plurality of artificial organs comprises an artificial bladder and/or an artificial cervix.

In certain embodiments of the simulation device, the container comprises a locking mechanism positioned in the opening. In certain embodiments of the simulation device, the locking mechanism comprises an outer part and an inner part.

In certain embodiments of the simulation device, artificial cervix is positioned through the opening.

In certain embodiments of the simulation device, the lid comprises an attachment and/or stabilization piece.

In certain embodiments of the simulation device, the abdominal wall comprises at least one of an artificial skin, an artificial subcuticula, an artificial fat, and an artificial fascia. In certain embodiments of the simulation device, the abdominal wall comprises an artificial skin, an artificial subcuticula, an artificial fat, and an artificial fascia.

In certain embodiments of the simulation device, the abdominal wall and/or artificial uterus is replaceable.

In certain embodiments of the simulation device, the plurality of artificial organs comprises a silicone.

In certain embodiments of the simulation device, the artificial uterus and the artificial cervix comprise a platinum cure liquid silicone and a two-component platinum silicone flexible foam. In certain embodiments of the simulation device, the artificial uterus and the artificial cervix comprise a 2:1 ratio of a platinum cure liquid silicone and a two-component platinum silicone flexible foam. In certain embodiments of the simulation device, the artificial uterus and the artificial cervix comprises a shore A hardness of from about 25 to about 35.

In certain embodiments of the simulation device, the artificial muscle comprises a platinum-catalyzed silicone. In certain embodiments of the simulation device, the artificial muscle comprises a shore A hardness of from about 00 to about 50.

In certain embodiments of the simulation device, the artificial skin comprises a platinum-catalyzed silicone. In certain embodiments of the simulation device, the artificial skin comprises a shore A hardness of from about 00 to about 30.

In certain embodiments of the simulation device, the artificial fat comprises a two-component platinum silicone flexible foam.

In certain embodiments of the simulation device, the artificial bladder comprises a platinum-catalyzed silicone or a two-component platinum silicone flexible foam.

In certain embodiments of the simulation device, the locking mechanism comprises a thermoplastic polyester.

In certain embodiments, the present disclosure is directed to A model for a uterus comprising: a plurality of artificial organs including at least a cervix and uterus; an abdominal wall containing the organs, wherein the abdominal wall, artificial cervix, and/or artificial uterus is replaceable; wherein the artificial organs and abdominal wall are cast in commercially available silicones, and wherein abdominal wall and organs provide realistic feedback to users.

It is to be understood that both the Summary and the Detailed Description are exemplary and explanatory only, and are not restrictive of the disclosure as claimed. While the invention has been described with reference to the embodiments herein, a person of ordinary skill in the art would understand that various changes or modifications may be made thereto without departing from the scope of the claims.

### BRIEF DESCRIPTION OF THE FIGURES

FIG. 1 depicts an embodiment of the simulation device.

FIG. 2 depicts an embodiment of the simulation device and a cross section view.

FIG. 3 depicts data for elastic moduli of native tissues and silicone analogs.

FIG. 4A depicts a roll model of an aspect of the simulation device.

FIG. 4B depicts a roll model of an aspect of the simulation device.

FIG. 4C depicts an embodiment of a uterus in the simulation device.

FIG. 4D depicts an embodiments of the locking mechanism.

FIG. 4E depicts various embodiments of the simulation device.

FIG. 4F depicts an embodiment of the abdominal wall component.

FIG. 5 depicts an embodiment of the simulation device.

FIG. 6 depicts an embodiment of the simulation device.

FIG. 7 depicts an embodiment of the abdominal wall component.

FIG. 8 depicts an embodiment of a uterus.

FIG. 9 depicts an embodiment of the abdominal wall lid.

FIG. 10 depicts an embodiment of the simulation device.

FIG. 11 depicts an embodiment of the simulation device.

FIG. 12 depicts an embodiment of the simulation device and a proposed medical use.

### DETAILED DESCRIPTION

Embodiments of the disclosure relate to a simulation device comprising a plurality of artificial organs and a container, wherein the plurality of artificial organs comprises an artificial uterus; an artificial cervix; an artificial muscle; and an artificial abdominal wall, and wherein the container comprises a lid and an opening.

Embodiments of the disclosure also relate to a method of medical training comprising providing a simulation device according to any of the disclosed embodiments and utilizing the simulation device to train a person to perform a medical procedure, including a Cesarean section and/or performing a medical procedure, including a Cesarean section, on the simulation device.

Applicant has surprisingly discovered that by utilizing the disclosed simulation device, it is possible to perform medically and clinically representative Cesarean section procedures in an easily transportable, lower cost, and efficient manner.

Various examples and embodiments of the subject matter disclosed are possible and will be apparent to a person of ordinary skill in the art, given the benefit of this disclosure. In this disclosure reference to “some embodiments,” “certain embodiments,” “certain exemplary embodiments” and similar phrases each means that those embodiments are non-limiting examples of the inventive subject matter, and there may be alternative embodiments which are not excluded.

The articles “a,” “an,” and “the” are used herein to refer to one or more than one (i.e., to at least one) of the grammatical object of the article. By way of example, “an element” means one element or more than one element.

As used herein, the term “about” means ±10% of the noted value. By way of example only, at least “about 50 mm” could include from at least 45 mm to and including at least 55 mm.

The word “comprising” is used in a manner consistent with its open-ended meaning, that is, to mean that a given product or process can optionally also have additional features or elements beyond those expressly described. It is understood that wherever embodiments are described with the language “comprising,” otherwise analogous embodiments described in terms of “consisting of” and/or “consisting essentially of” are also contemplated and within the scope of this disclosure.

An objective for embodiments of the disclosure was to create a mid-fidelity benchtop CS training model to meet the needs of Uganda's training program, Essential Training in Operative Obstetrics (ETOO), and considered: using the Joel Cohen cesarean surgical technique (JCM) which utilizes blunt dissection, identifying and manipulating the bladder to avoid accidental incisions, and properly suturing tissues. All three skills are critical to reducing complications and improving maternal healing. To simulate CS in accordance with these three critical skills, the model can have components resembling the uterus, bladder, abdominal muscle, fat and skin that accurately represent the anatomical geometries and mechanical properties of native tissues.

Design Consideration: Overall, the model was considered in design for use in developing and developed countries. To remain accessible, all materials and components used in the model can be cost effective, commercially available, and nontoxic. Additionally, as physicians travel to training programs in underserved countries, the model can be globally transportable; therefore, it can comply with commercial airline size and weight restrictions. The model was also constrained by the training methods that it must support. The physicians teach JCM, and the model can accommodate the standard incisions and tissue stretching that is characteristic of this technique. Additionally, the model can be adaptable for part-task training, meaning it can be easily and quickly disassembled. The individual components can then be used separately to train specific portions of the procedure. An additional request was the inclusion of an open cervix for manual manipulation of the fetus and additional capabilities.

Embodiments of the disclosure can meet certain standards for successful use as a simulation device. (1) Joel Cohen Method: The model's size must fit the standard 10-15 cm transverse incision and 7-12 cm longitudinal stretching of the abdominal wall. JCM additionally entails stretching of the skin, fat, abdominal muscle, and uterus; the materials selected for their respective tissue analogs should replicate native tensile elastic moduli as reported in literature (skin: 4.0±3.81 MPa, fat: 11.7±6.4 kPa, abdominal muscle: 42.5±9.0 kPa, myometrium at full term: 0.51-2.33 MPa). As properly stitching tissues is crucial to maternal recovery, the materials used must also be able to hold sutures without tearing. (2) Anatomical Geometry: The model should also replicate anatomical geometry to ensure the skills mastered on the model are easily translated to use in practice. A uterus at full term has dimensions of 35×25×20 cm and a myometrial thickness of 4.68±0.48 mm. The thicknesses of skin, fat, and abdominal muscle tissues are 1.2±0.3 mm, 13±2.7 mm, 9.8±1.7 mm respectively. In certain embodiments, the artificial fat thickness can be adjusted, increased, or decreased to represent a specific patient population and/or to further aid students and practitioners. In certain embodiments, the components of the simulation device comprise a tensile elastic moduli as shown in this paragraph. In certain embodiments, the components of the simulation device comprise the dimensions as shown in this paragraph. In certain embodiments, the components of the simulation device comprise the myometrial thickness as shown in this paragraph. In certain embodiments, the components of the simulation device comprise the thickness as shown in this paragraph.

In certain embodiments, the model can allow for 5-10 uses before any components require replacement and can cost US$1 per use. In certain embodiments, the simulation device can be assembled and or disassembled in time of <5 mins. In certain embodiments, the simulation device can have a perimeter of <62 in and a weight of <50 lbs or <158 cm and <32 kg (which meets airline luggage restrictions).

Multiple simulation devices were prepared in accordance with Applicant's experimentation and preparation. Any alleged drawbacks are not meant to limit the scope of the disclosure and comments are only related to design preference. Certain benefits are disclosed, however, which may have been unexpected prior to this disclosure and can allow for ever superior use as a simulation device.

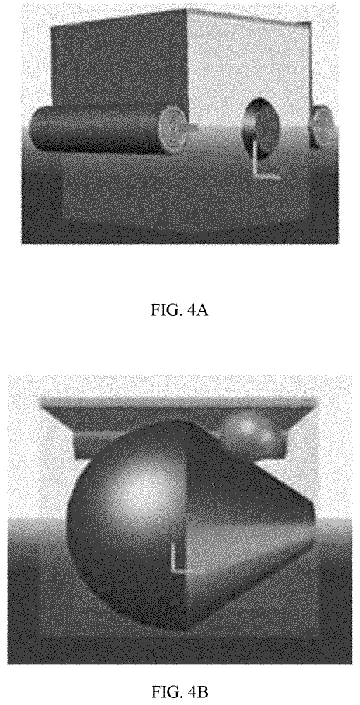

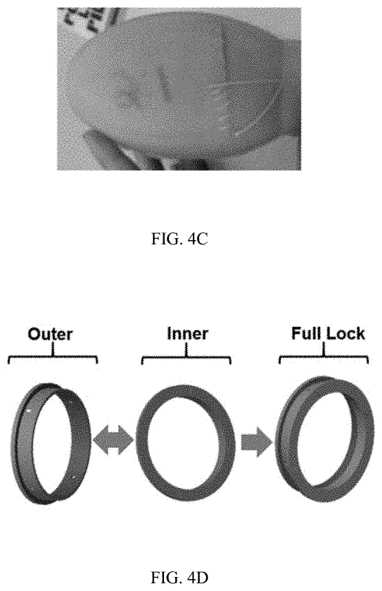

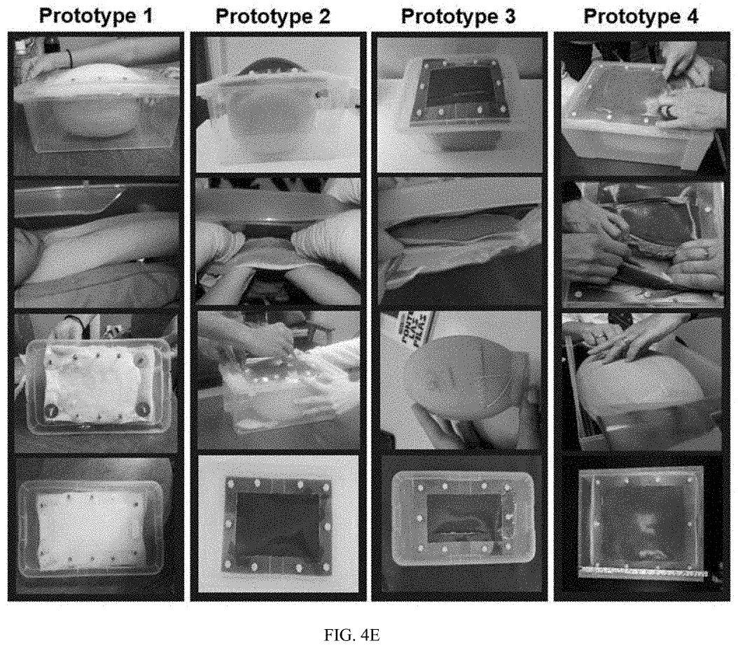

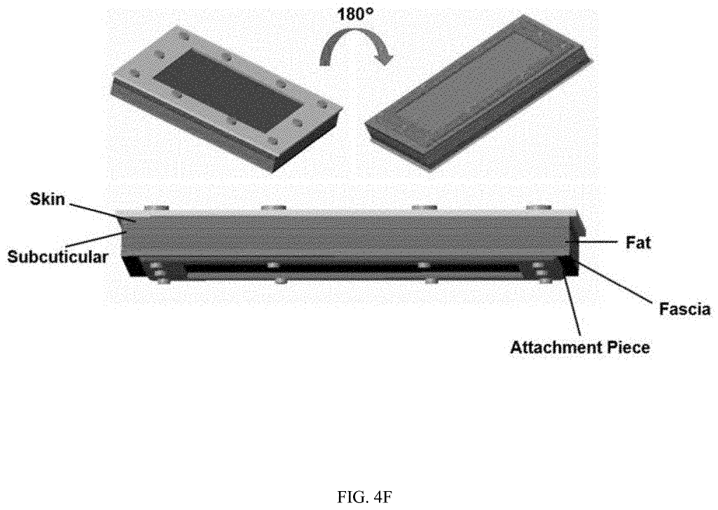

Design Concept 1: Roll Model for Abdominal Wall: The first design approach included the layers of the abdominal wall provided in excess in the form of a roll (e.g., FIGS. 4A and 4B). A feasibility experiment revealed this design was too bulky and cumbersome to be practical. Feedback on this design showed that important components were missing from the abdominal wall including: fascia, a subcuticular layer, and hard stops.

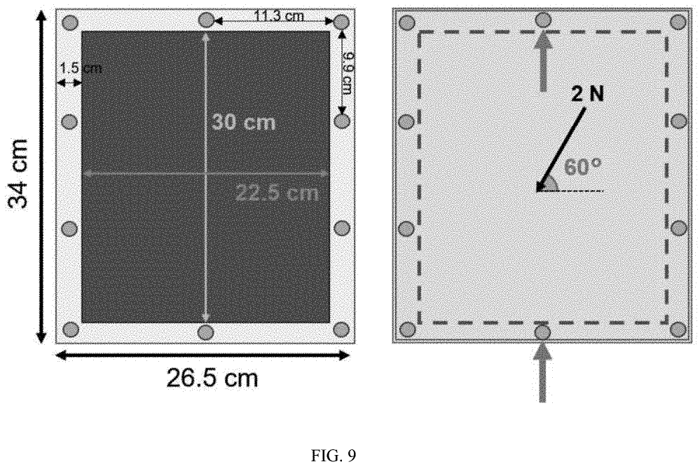

Design Concept 2: Frame Model for Abdominal Wall: The next design iteration involved using a generic plastic box as the model's container, with the abdominal wall layers attached to the underside of the box's lid. This minimized material used, reducing overall costs, and provided a hard stop as requested by physician stakeholders. A proof of concept of this design revealed the approach was feasible for its ability to remain taut and form a dome from intra-abdominal pressure. After multiple meetings with physician stakeholders, this design was refined and selected for the final model. Adjustments were made to the layers of the abdominal wall, and a subcuticular layer simulated by thin fabric was added in between the skin and fat analog to aid in holding sutures. Additionally, the decision was made to glue the layers of the abdominal wall together to prevent them from separating when incised, improving representation of native tissue. Mathematical Model: Feasibility of Frame Design: Before moving to prototyping the design, a mathematical model was developed to ensure this design was feasible. The resulting force at each screw was determined from an incision force of 2N at an angle of 60°, which is required to penetrate skin. This was done to verify the material used for skin analogue, the thinnest layer, would not tear at the attachment points when under tension from the incision force. The points indicated by the pink arrows in FIG. 9 (right) experienced the maximum force of 0.75N, which translates to a pressure of 3.8 kPa on the surrounding material. This pressure is much lower than the ultimate tensile strength of the skin analogue (1.39 MPa), indicating that this was a feasible design to move forward with.

The next design iteration involved using a generic plastic box as the model's container, with the abdominal wall layers attached to the underside of the box's lid. This minimized material used, reducing overall costs, and provided a hard stop as requested by physician stakeholders. A proof of concept of this design (FIG. 4E, “Prototype 1”) revealed the approach was feasible for its ability to remain taut and form a dome from intra-abdominal pressure. Adjustments were made to the layers of the abdominal wall, and a subcuticular layer simulated by thin fabric was added in between the skin and fat analog to aid in holding sutures. Additionally, the decision was made to glue the layers of the abdominal wall together to prevent them from separating when incised, improving representation of native tissue.

Final Design Concept: The proposed solution simulation device comprises of artificial organs and an abdominal wall cast in commercially available silicones. The model was designed to maximize uses and reduce cost. Each component is removable to allow for part-task training as well as for easy replacement once the maximum amount of incisions have been made.

In certain embodiments, the present disclosure is directed to a simulation device comprising a plurality of artificial organs and a container, wherein the plurality of artificial organs comprises an artificial uterus; an artificial cervix; an artificial muscle; and an artificial abdominal wall, and wherein the container comprises a lid and an opening.

In certain embodiments, the container can comprise a plastic.

In certain embodiments of the simulation device, the plurality of artificial organs comprises an artificial bladder. In certain embodiments of the simulation device, the artificial bladder comprises a platinum-catalyzed silicone or a two-component platinum silicone flexible foam. In certain embodiments, the bladder can be made from a material under the trade name Ecoflex™ 00-10 and Soma Foama™ 15.

In certain embodiments of the simulation device, the container comprises a locking mechanism positioned in the opening. In certain embodiments of the simulation device, the locking mechanism comprises an outer part and an inner part. In certain embodiments of the simulation device, the simulation device comprises an artificial cervix and the artificial cervix is positioned through the opening. In certain embodiments of the simulation device, the locking mechanism comprises a thermoplastic polyester. In certain embodiments, the thermoplastic polyester is polylactic acid.

In certain embodiments of the simulation device, the lid comprises an attachment and/or stabilization piece. In certain embodiments, the attachment and/or stabilization piece can be positioned underneath the abdominal wall components underneath the lid, over nylon screws, then secured by an acrylic “frame” (FIG. 12).

In certain embodiments of the simulation device, the abdominal wall comprises at least one of an artificial skin, an artificial subcuticula, an artificial fat, and an artificial fascia. In certain embodiments of the simulation device, the abdominal wall comprises an artificial skin, an artificial subcuticula, an artificial fat, and an artificial fascia.

In certain embodiments of the simulation device, the abdominal wall and/or artificial uterus is replaceable.

In certain embodiments of the simulation device, the plurality of artificial organs comprises a silicone.

In certain embodiments, the artificial subcuticula can comprise cloth fabric, such as cotton.

In certain embodiments, the artificial fascia can comprise cloth fabric, such as cotton.

In certain embodiments, the simulation device comprises a connective tissue analog. In certain embodiments, the connective tissue analog comprises glue or other adhesive spray in between silicone and cloth layers.

In certain embodiments of the simulation device, the artificial uterus and the artificial cervix comprise a platinum cure liquid silicone and a two-component platinum silicone flexible foam. In certain embodiments of the simulation device, the artificial uterus and the artificial cervix comprise a 2:1 ratio of a platinum cure liquid silicone and a two-component platinum silicone flexible foam. In certain embodiments of the simulation device, the artificial uterus and the artificial cervix comprises a shore A hardness of from about 25 to about 35. In certain embodiments, the artificial uterus and/or the artificial cervix can be made from a material under the trade name Dragon Skin™ 30 and Soma Foama™ 15. In certain embodiments, the materials can have about a 30 A shore hardness, about a 500 psi tensile strength, and/or about a 15 lb./cu. ft. cell structure (240 kg/m³) (such as a 13.5 lb/cu. ft. to 16.5 lb./cu. ft. cell structure).

In certain embodiments of the simulation device, the artificial muscle comprises a platinum-catalyzed silicone. In certain embodiments of the simulation device, the artificial muscle comprises a shore A hardness of from about 00 to about 50. In certain embodiments, the artificial muscle can be made from a material under the trade name Ecoflex™ 00-50. In certain embodiments, the artificial muscle can have about a 00-50 shore A hardness, about a 315 psi tensile strength, and/or about 12 psi 100% modulus. In certain embodiments, the muscle layer can be cut and can have rip-stop nylon embedded around the ends of the cut.

In certain embodiments of the simulation device, the artificial skin comprises a platinum-catalyzed silicone. In certain embodiments of the simulation device, the artificial skin comprises a shore A hardness of from about 00 to about 30. In certain embodiments, the artificial skin can be made from a material under the trade name Ecoflex™ 00-30. In certain embodiments, the artificial skin can have about a 00-30 shore A hardness, about a 200 psi tensile strength, and/or about a 10 psi 100% modulus.

In certain embodiments of the simulation device, the artificial fat comprises a two-component platinum silicone flexible foam. In certain embodiments, the artificial fat can be made from a material under the trade name Soma Foama™ 15. In certain embodiments, the artificial fat can have about a 15 lb./cu. ft. cell structure (240 kg/m³).

In certain embodiments, the present disclosure is directed to A model for a uterus comprising: a plurality of artificial organs including at least a cervix and uterus; an abdominal wall containing the organs, wherein the abdominal wall is replaceable; wherein the artificial organs and abdominal wall are cast in commercially available silicones, and wherein abdominal wall and organs provide realistic feedback to users.

An innovation of this design is the abdominal wall component, which can be used individually to train multiple laparotomies. This component is also unique in that it can be removed from the container, rotated 180°, and put back into place for a fresh incision surface. No other model on the market is designed in such a way. The uterine component was made symmetrical, forgoing exact anatomical geometry, to maximize the number of incisions capable before replacement, further reducing the model's overall cost. The rounded, hollow shape of the component is innovative as most models only provide a flat uterine layer, not congruent with uterine natural geometry. The rounded, protruding abdomen provides realistic feedback to trainees.

In certain embodiments, the simulation device comprises a locking mechanism. The locking mechanism connects the cervical and uterine analogs with each other and the container. The lock contains two 3D-printed parts that twist together (FIG. 4D). The outer component attaches to the container, providing greater stability to the uterine-cervical connection when procedures involving cervical manipulation are performed. Notably, the inner component was designed with a stabilization rim that the uterine analog stretches over, holding the uterus in place. There are four locations where the cervical analog can be fastened using brad pins, allowing the uterus to be rotated about the component to maximize incisions. The specifications for the locking mechanism is in Table 1.

TABLE 1
Specification, Value, and Justification
for Locking Mechanism Component

| Specification | Value | Justification |
|---|---|---|
| Diameter | 106 mm | Fully dilated cervix (10 cm) + 0.6 cm for |
| | | silicone thickness, determined by |
| | | cervical effacement at 38 weeks gestation |

The removable, simulated cervix can be composed of a silicone casing containing a foam that allows it to stretch and return to its original geometry; providing accurate tactile feedback based on what is expected of a 90-100% effaced cervix. The specifications are listed in Table 2. This allows for the practice of manual manipulation of the neonate through the cervical opening, as well as other procedures (such as balloon tamponade).

TABLE 2
Specification, Value, and Justification of Cervical Analog.

| Specification | Value | Justification |
|---|---|---|
| Thickness | 0.6 cm | Average thickness of endocervical |
| | | canal in active labor |
| Length | 36.58 ± 4.58 mm | Average length of endocervical canal |
| | | in active labor |
| Material | Platinum Cured-Silicone Rubber | Simulate tactile feedback during |
| | (Hardness 50 A) with inner foam layer | cervical procedures |

The bladder was designed as an individual component, attached to the lower uterine segment via Velcro for the ability to be moved away from the location of uterine incision. This component serves as a static marker (visual) for students to remind them to avoid the bladder during the procedure, as well as a dynamic marker (moving out of the way) as requested by the instructor. Students will not be making incisions in the bladder; thus, a specific elastic modulus or tactility was not detailed nor requested by physicians.

The simulated uterus is cast from an experimentally determined ratio of silicones based on physician feedback of tactile representation, and ability to maintain shape and provide pressure against the abdominal wall creating the characteristic rounded shape of a pregnant abdomen. Design specifications for the uterine analog are listed in Table 3.

TABLE 3
Specification, Value, and Justification for Uterine Analog

| Specification | Value | Justification |
|---|---|---|
| Thickness | 5 mm | Thickness of lower myometrium |
| | | (incision site) |
| Dimensions | 32.5 × 20 × 20 cm | Based on dimensions of a full-term |
| | (L × W × D) | pregnant uterus |
| Material | 2 Dragon Skin 30A: | Selected by physician feedback |
| | 1 Soma Foama 15 | |

The muscle layer was designed as an individual part, separate from the abdominal wall. The muscle is not incised during CS because the diastasis recti naturally separate from pressure during pregnancy; therefore, the component does not need to be replaced. The anatomical geometry supports the goal of achieving maximum amount of uses per model. For assembly, this layer is simply placed over the uterine component, and stretched by the pressure exerted on it from below. The component is able to be stretched. The specifications for the muscle analog are listed in Table 4.

TABLE 4
Specification, Value, and Justification for Muscle Analog

| Specification | Value | Justification |
|---|---|---|
| Thickness | 10 mm | Thickness of abdominal muscle |
| | | for a 25-44 |
| Material | Platinum Cured-Silicone | Selected for elastic modulus |
| | Rubber (Ecoflex 00-50) | similar to native tissue |

The abdominal wall is composed of skin, fat, connective tissue, and fascia analogs held together by silicone adhesives and secured to the lid of the model. Ten attachment points were made in the lid to secure the abdominal wall. In order to better distribute forces upon layer stretching, an attachment piece (FIG. 4F) was designed to provide further stability to the abdominal wall. The design specifications for the abdominal wall analogs, box lid, and attachment piece are listed in Table 5.

TABLE 5
Component, Specification, Value, and Justification for Abdominal Wall

| Component | Specification | Value | | Justification |
|---|---|---|---|---|
| Lid of box | Length × Width | 36.8 × 29.8 cm | | Affords space for a 10-15 cm incision per |
| Attachment | | 29.5 × 24 cm | | |
| Piece Skin | | | | JCM and additional stretching |
| | Thickness | <1.5 | mm | Average thickness of epithelium |
| | Material | Platinum Cured-Silicone | | Selected for positive physician |
| | | Rubber (Ecoflex 00-30) | | feedback |
| Fat | Thickness | 11 | mm | Maternal abdominal |

| | | |
|---|---|---|
| Material | Soma Foama 15 | subcutaneous fat thickness, |
| | | underweight BMI (<18.5) |
| | | Selected for accurate elastic |
| | | modulus and |
| | | positive physician feedback |

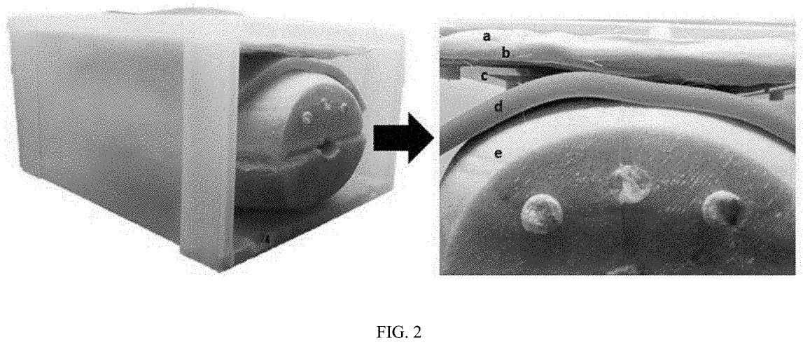

The final simulation device model is shown in FIG. 2. A series of images documents the progression of the model through each iteration (FIG. 4E).

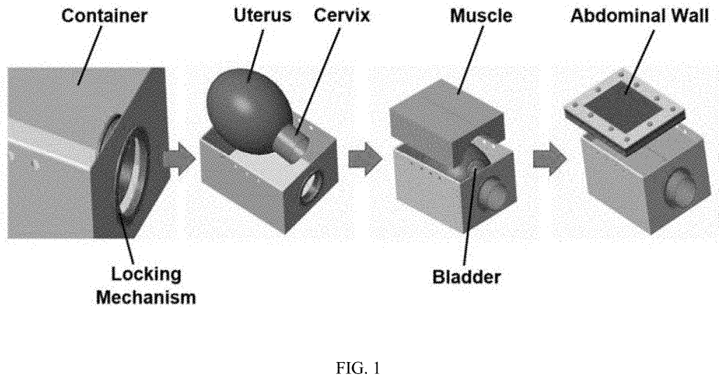

FIG. 1 depicts a solution schematic showing assembly of cervix, uterus, muscle, and abdominal wall.

FIG. 2 depicts an embodiment of the simulation device (left) with zoomed in cross section (right) showing skin and subcuticular layers (a), fat (b), fascia (c), abdominal muscle (d) and uterine (e) components.

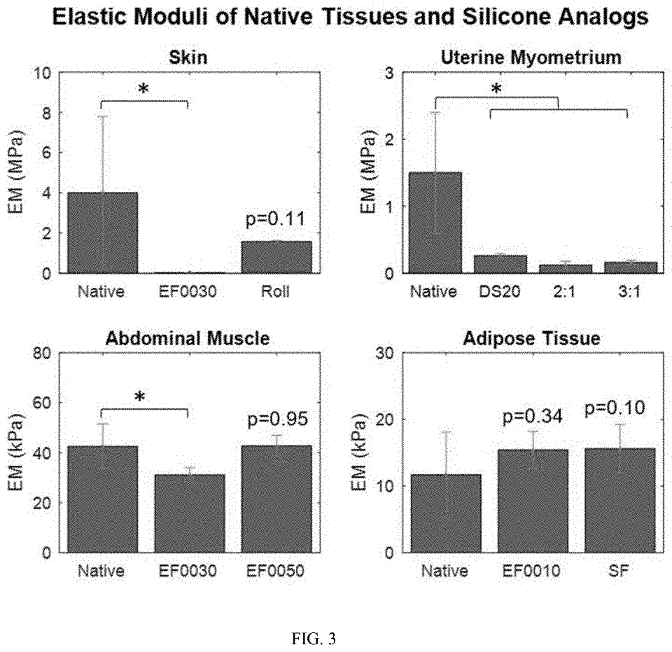

FIG. 3 depicts verification testing (ASTM D412-16) Elastic moduli of silicones compared to native tissues (values from literature).

FIG. 4A depicts a roll model of an aspect of the simulation device.

FIG. 4B depicts a roll model of an aspect of the simulation device.

FIG. 4C depicts a small scale uterus from a first casting trial of 2:1 ratio of DragonSkin 30:Soma Foama 15.

FIG. 4D depicts Components of Locking Mechanism (1) Outer part (2) Inner part (3) Full mechanism when outer and inner parts are attached.

FIG. 4E depicts various embodiments of the simulation device and shows a progression of model over multiple periods of discussion and redesign.

FIG. 4F depicts an embodiment of the abdominal wall component showing tissue analog layers and attachment mechanisms.

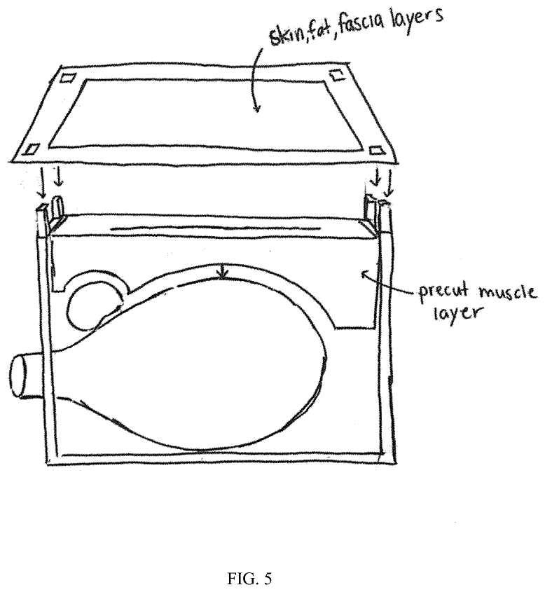

FIG. 5 depicts an embodiment of the simulation device, showing skin, fat, and fascia layers, and a precut muscle layer.

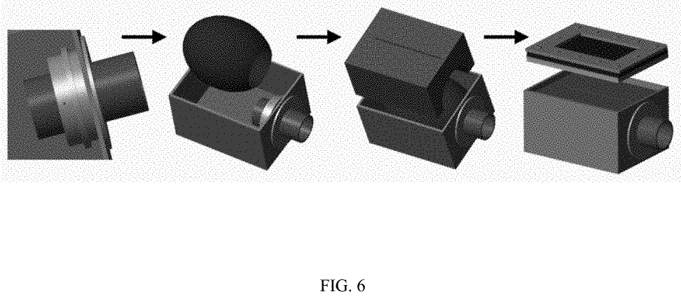

FIG. 6 depicts a solution schematic showing assembly of cervix, uterus, muscle, and abdominal wall.

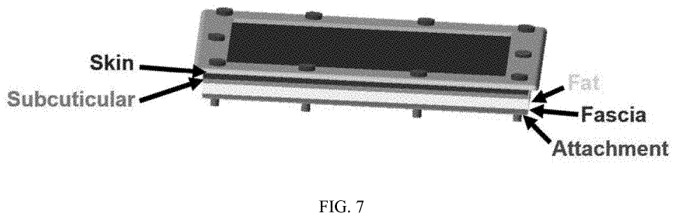

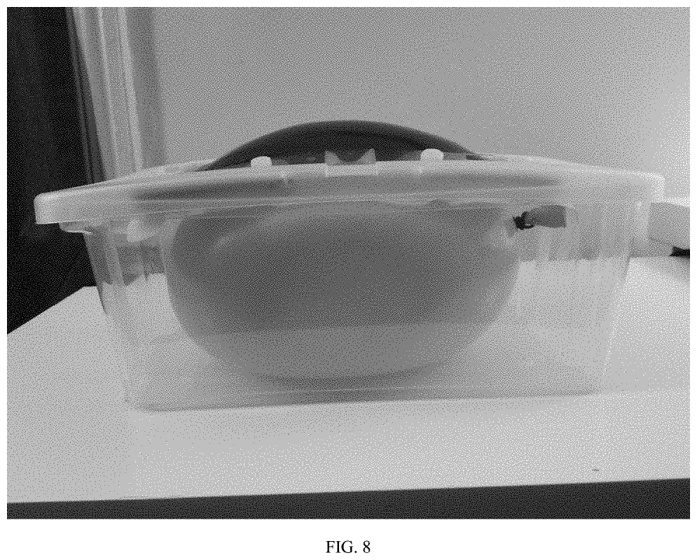

FIG. 7 depicts an embodiment of the abdominal wall component showing tissue analog layers and attachment mechanisms.

FIG. 8 depicts an embodiment of a uterus.

FIG. 9 depicts an embodiment of the abdominal wall lid, showing dimensions of lid with positioning of screws (left) and points of max force (right).

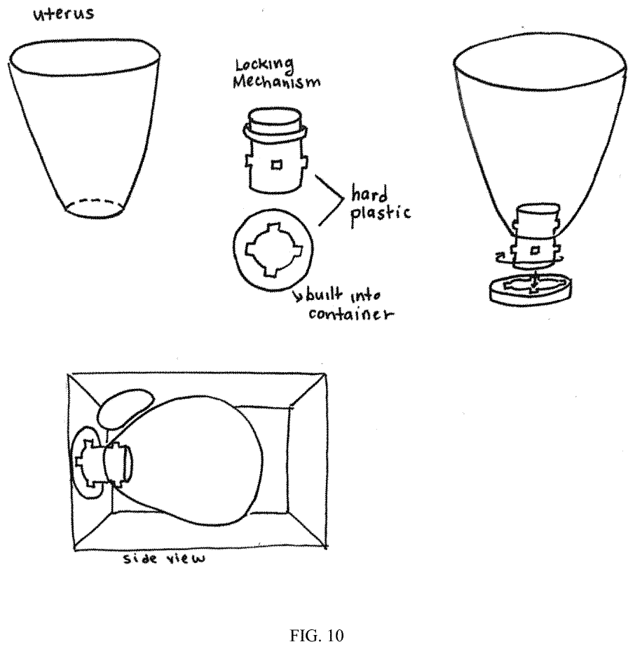

FIG. 10 depicts an embodiment of the simulation device, showing a uterus, a locking mechanism and related materials, a connection between the uterus and the locking mechanism, and a side view of the simulation device.

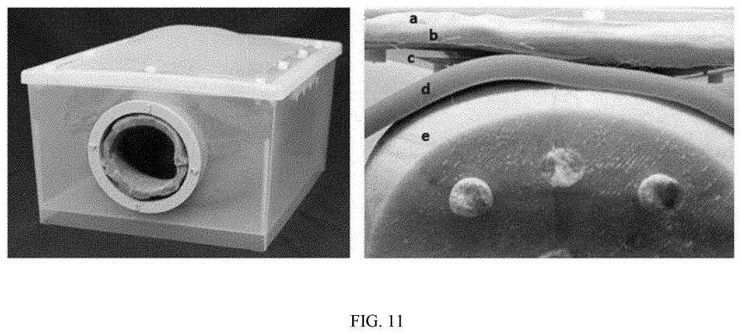

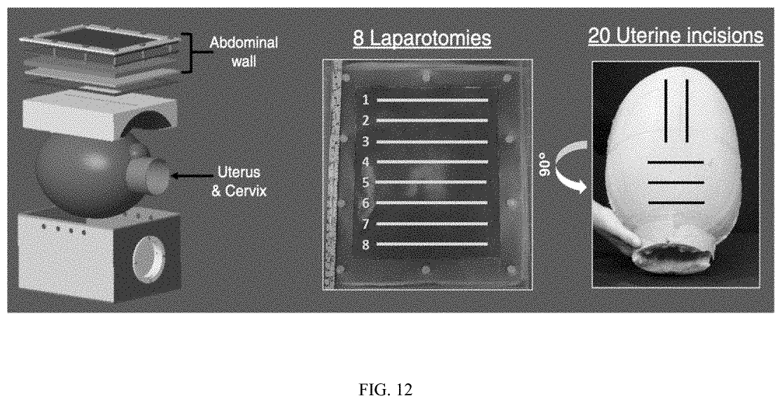

FIG. 11 depicts an embodiment of the simulation device (left) with zoomed in cross section (right) showing skin and subcuticular layers (a), fat (b), fascia (c), abdominal muscle (d) and uterine (e) components.

FIG. 12 depicts an embodiment of the simulation device and shows potential components (left), a proposed medical use showing potential laparotomies (middle), and potential uterine incisions (right).

### EXAMPLES

The model, objects, and devices described herein are now further detailed with reference to the following examples. These examples are provided for the purpose of illustration only and the embodiments described herein should in no way be construed as being limited to these examples. Rather, the embodiments should be construed to encompass any and all variations which become evident as a result of the teaching provided herein.

### Example: Verification Test Methods and Analysis

Elastic modulus of simulated tissues: Tensile testing of the skin, fat, abdominal muscle, and myometrium analogs was performed in accordance with ASTM D412-16: Standard Test Methods for Vulcanized Rubber and Thermoplastic Elastomers-Tension. Statistics were performed by a two-sample t-test, α=0.05.

Physical geometries and thicknesses of the model components: Measurements followed ASTM D3767-03: Standard Practice for Rubber-Measurement of Dimensions to ensure tissue analogs met their respective specifications. This procedure involved using a micrometer, caliper, or 1 mm graduated ruler to make a minimum of three measurements for lengths of <30 mm, 30-100 mm, and >100 mm, respectively.

Assembly time: Third party users were timed to establish the average time required to completely assemble a model after reading the included instruction manual.

Cost per use of final model: The total cost of replaceable materials required to make one complete model was divided by the number of uses per each model as determined by physician advisors.

Model size and weight: Overall dimensions of the model were also determined using ASTM D3767-03. The model weight was determined from a completely assembled model.

Verification Results and Discussion:

Elastic moduli of simulated tissues: The tensile elastic moduli (EM) of native tissues and the considered silicones are shown in FIG. 3. Skin has an elastic modulus of 4±3.8 MPa; however, the selected material Ecoflex 00-30™ (EF0030)'s EM was 31.1±2.9 kPa. Although statistically different from native tissue, EF0030 was the physicians' preference and therefore used in the model. Three silicones were tested to simulate the myometrium: Dragon Skin™ 20A (DS20), and mixtures of Dragon Skin™ 30A (DS30) and Soma Foama™ 15 (SF) at 2:1 and 3:1 wt %. Neither of the three silicones accurately represented the EM of full term myometrium (0.5-2 MPa), with values of 0.26±0.03, 0.12±0.06, and 0.16±0.03 MPa, respectively. However, the 2:1 ratio of DS30:SF was selected by the physicians as tactilely accurate. Two silicones were tested for abdominal muscle: EF0030 and Ecoflex™ 00-50 (EF0050). EF0030 (31.1±2.9 kPa) was not an accurate representation of abdominal muscle, and was deemed too elastic by the physician stakeholders. EF0050 replicated the EM of native abdominal muscle (42.7±4.2 kPa and 42.5±9.0 kPa, respectively; p=0.95), and was also approved by physicians. Two silicones were tested as fat analogs: Ecoflex™ 00-10 (EF0010) and SF. The EM of adipose tissue (11.7±6.4 kPa) was replicated by both EF0010 (15.4±2.8 kPa, p=0.34) and SF (15.6±3.6, p=0.10), however SF had better tactile properties. Although only two of the four tissues met their mechanical requirements, all of the chosen silicones were approved by physician stakeholders after multiple sessions of incising, stretching, and suturing. As the OB/GYNs have the best understanding of tissue's tactile behavior and are the final users, the failure to meet the moduli of skin and uterine tissue does not hinder the effectiveness of the design.

Physical geometries of the model components: The results for model geometries and significance are summarized in Table 6. The uterine component is slightly smaller than the native organ. This was deemed acceptable due to the patient population in SSA being physically smaller than that in the USA. The component is also an ellipsoid rather than pear-shaped to allow for increased uses without replacement of parts. The uterine thickness originally failed to meet the requirement due to an error in the mold; however, an addition to the uterine mold has been modified to reduce thickness and meet the requirement in the next iteration. The thickness of skin analog also failed to meet the requirement, however, it was difficult to make a silicone sheet with the thickness of native skin that did not rip when stretched onto the lid in assembly. Additionally, this small difference of half a millimeter was not detectable by the physicians. The fat and abdominal muscle thicknesses met the requirement for native tissue.

TABLE 6
Verification Results for Model Anatomical Geometry

| Component | | Requirement | Recorded Values | p (α = 0.05) | Pass/Fail |
|---|---|---|---|---|---|
| Uterus | Geometry | 35 × 25 × 20 cm | 32.5 × 20 × 20 cm | N/A | Pass |
| | Thickness | 4.68 ± 0.48 mm | 5.1 ± 0.3 mm | p = 0.19 | Pass |
| Skin | Thickness | 1.16 ± 0.26 mm | 1.7 ± 0.6 mm | p = 0.02 | Fail |
| Fat | | 13.0 ± 2.7 mm | 11.8 ± 0.3 mm | p = 0.44 | Pass |
| Abdominal | | 9.8 ± 1.7 mm | 10.7 ± 0.5 mm | p = 0.21 | Pass |
| Muscle | | | | | |

Assembly time: The average time recorded to assemble a model was determined by third party users (n=3). The average assembly time was 47.5±13.1 secs, which is well within the 5-minute goal.

Cost per use: The total cost of replaceable materials required to make one complete model was divided by the number of uses per each model, as determined by physician advisors. The abdominal wall was determined by physicians to accommodate 8 laparotomies before requiring replacement, and the uterine component 20 incisions total before replacement: 12 JCM incisions and 8 vertical incisions. Vertical incisions are performed in emergent cases such as fibroid, cervical cancer, and anterior placenta accreta; this opportunity to train rare cases can further increase physician competency. Each laparotomy costs US$2.01 and each uterine incision costs US$1.02, for a total cost of US$3.03 per complete JCM CS. The achieved cost is a significant improvement compared to existing models on the market, and is still accessible to the model's intended customers of international not-for-profit organizations and universities. Increasing the scale of production will save costs on bulk material and manufacturing efficiencies.

Model size and weight: The model's overall dimensions were (37.6±0.6 cm×25.0±0.3 cm×31.1±0.1 cm) for a total perimeter of 93.6±0.9 cm. The model's weight was 3.8±0.3 kg; the model is well within the goal of <158 cm and <32 kg for airline restrictions (<62 in and a weight of <50 lbs).

Validation Test Methods: Model accuracy and performance: OB/GYN faculty and residents evaluated the tissue analogs' tactile and tensile accuracy and ability to hold sutures, as well as the models' overall competency in teaching a CS via a survey. The survey encompassed ranking different components on a scale of 1-5, identifying model strengths and weaknesses, and comparing to currently used models.

Validation Results and Discussion: The feedback from OB/GYN physicians and residents over time is listed below in Table 7. Model quality and ability to teach JCM was rated on a scale of 1-5, with 5 being the best. When comparing to existing models, a value of 3 indicated no difference, 1-2 a decline, and 4-5 an improvement in quality (empty cells indicate no response). The first prototype is not included as it was a proof of concept and a starting point for physicians to give direction. Each iteration received physician feedback to improve the model, leading to the final prototype. Generally, model quality improved with each iteration. Many physicians noted that it is impossible to perfectly replicate human tissue with affordable synthetic materials, which they would deem a quality of ‘5’. Despite this, it was consistently reported that the model made significant improvements from those that are currently in use, as indicated by the average score of 4.5.

TABLE 7
Validation Results from Physicians and Residents

| | | | | Final |
|---|---|---|---|---|
| | Prototype 2 | Prototype 3 | Prototype 4 | Prototype |
| Overall quality | 3.5 | 4.0 | 3.9 ± 0.8 | 4.2 ± 0.4 |
| Teaching JCM | — | 4.0 | — | 4.0 ± 0.0 |
| Compared | — | — | 4 ± 0.0 | 4.5 ± 0.6 |
| Quality | | | | |

What is claimed is:

1. A simulation device comprising a plurality of artificial organs and a container, wherein the plurality of artificial organs comprises
a. an artificial uterus;
b. an artificial muscle; and
c. an artificial abdominal wall, and
wherein the container comprises a lid and an opening.

2. The simulation device according to claim 1, wherein the plurality of artificial organs comprises an artificial bladder and/or an artificial cervix.

3. The simulation device according to claim 1, wherein the container comprises a locking mechanism positioned in the opening.

4. The simulation device according to claim 3, wherein the locking mechanism comprises an outer part and an inner part.

5. The simulation device according to claim 3, comprising an artificial cervix and wherein the artificial cervix is positioned through the opening.

6. The simulation device according to claim 1, wherein the lid comprises an attachment and/or stabilization piece.

7. The simulation device according to claim 1, wherein the abdominal wall comprises at least one of an artificial skin, an artificial subcuticula, an artificial fat, and an artificial fascia.

8. The simulation device according to claim 1, wherein the abdominal wall comprises an artificial skin, an artificial subcuticula, an artificial fat, and an artificial fascia.

9. The simulation device according to claim 1, wherein the abdominal wall and/or artificial uterus is replaceable.

10. The simulation device according to claim 1, wherein the plurality of artificial organs comprises a silicone.

11. The simulation device according to claim 1, wherein the artificial uterus comprises a platinum cure liquid silicone and a two-component platinum silicone flexible foam.

12. The simulation device according to claim 1, wherein the artificial uterus comprises a 2:1 ratio of a platinum cure liquid silicone and a two-component platinum silicone flexible foam.

13. The simulation device according to claim 1, wherein the artificial uterus comprises a shore A hardness of from about 25 to about 35.

14. The simulation device according to claim 1, wherein the artificial muscle comprises a platinum-catalyzed silicone.

15. The simulation device according to claim 1, wherein the artificial muscle comprises a shore A hardness of from about 00 to about 50.

16. The simulation device according to claim 7, wherein the artificial skin comprises a platinum-catalyzed silicone.

17. The simulation device according to claim 7, wherein the artificial skin comprises a shore A hardness of from about 00 to about 30.

18. The simulation device according to claim 7, wherein the artificial fat comprises a two-component platinum silicone flexible foam.

19. The simulation device according to claim 2, wherein the bladder comprises a platinum-catalyzed silicone or a two-component platinum silicone flexible foam.

20. The simulation device according to claim 3, wherein the locking mechanism comprises a thermoplastic polyester.
